(19) United States
(12) Patent Application Publication
(10) Pub. No.: US 2024/0236262 A9
(43) Pub. Date: Jul. 11, 2024

(54) DISPLAY DEVICE

(71) Applicant: Funai Electric Co., Ltd., Osaka (JP)

(72) Inventor: Daisuke ISHIBASHI, Osaka (JP)

(21) Appl. No.: 18/457,443

(22) Filed: Aug. 29, 2023

(30) Foreign Application Priority Data
Oct. 19, 2022 (JP) 2022-167958

(51) Int. Cl. H04N 5/64; G02F 1/1333; H04N 5/655

(52) U.S. Cl. CPC H04N 5/642; G02F 1/133314; H04N 5/655

(57) ABSTRACT

A display device is provided with a display, a rear frame disposed on a rear side of the display, a speaker attached to the rear frame such that a tilt angle of the speaker with respect to the rear frame is changeable, a cover member attached to the rear frame to cover the speaker such that the speaker is located inside the cover member, and an angle change mechanism configured to change the tilt angle of the speaker with respect to the rear frame from outside the cover member while the speaker is covered by the cover member.

### CROSS-REFERENCE TO RELATED APPLICATIONS

This application claims priority to Japanese Patent Application No. 2022-167958 filed in Japan on Oct. 19, 2022. The entire disclosure of Japanese Patent Application No. 2022-167958 is hereby incorporated herein by reference.

### BACKGROUND

### Field of the Invention

The present invention generally relates to a display device. More specifically, the present invention relates to a display device with a speaker mounted on a rear side of a rear frame.

### Background Information

Conventionally, a display device with a speaker mounted on a rear side of a rear frame is known (see Japanese Patent Application Publication No. 2021-192482 (Patent Literature 1), for example).

In Patent Literature 1, a display device is disclosed with a rear housing (a rear frame) located on a rear side of a display unit, a speaker located above a rear side of the rear housing, and a cover member covering a part of the rear housing. In Patent Literature 1, the speaker positioned upward is configured to output sound upwardly and is also configured to change its mounting angle relative to the rear housing. The speaker is exposed and is not covered by the cover member.

### SUMMARY

Speakers that are exposed to the outside as disclosed in Patent Literature 1 may be subject to foreign matter including dust and dirt. Therefore, it is conceivable to cover the speaker with a cover member. However, when the speaker is covered with a cover member, there is a problem that the angle of the speaker cannot be adjusted without removing the cover member.

One object of the present disclosure is to provide a display device capable of preventing foreign matter from adhering to a speaker and also capable of changing the angle of the speaker.

In view of the state of the known technology, a display device is provided with a display, a rear frame disposed on a rear side of the display, a speaker attached to the rear frame such that a tilt angle of the speaker with respect to the rear frame is changeable, a cover member attached to the rear frame to cover the speaker such that the speaker is located inside the cover member, and an angle change mechanism configured to change the tilt angle of the speaker with respect to the rear frame from outside the cover member while the speaker is covered by the cover member.

### BRIEF DESCRIPTION OF THE DRAWINGS

FIG. 1 is an exploded perspective view illustrating the configuration of a liquid crystal television device according to a first embodiment.

FIGS. 2A and 2B include diagrams illustrating an angle change mechanism according to the first embodiment, FIG. 2A shows a tilt angle before the change, and FIG. 2B shows the tilt angle after the change.

FIG. 3 is a partial enlarged view of the angle change mechanism according to the first embodiment.

FIG. 4 is an exploded perspective view of the configuration of a liquid crystal television device according to a second embodiment.

FIG. 5 is a diagram illustrating a state in which an angle change mechanism according to the second embodiment is attached to a speaker.

FIG. 6 is a bottom view of the angle change mechanism according to the second embodiment.

FIG. 7 is a diagram illustrating a rear surface of a cover member according to the second embodiment.

FIG. 8 is a partial cross-sectional view illustrating a state in which the angle change mechanism is attached to a rear frame.

FIG. 9 is an exploded perspective view of the configuration of a liquid crystal television device according to a third embodiment.

FIGS. 10A and 10B include diagrams illustrating an angle change mechanism according to the third embodiment, FIG. 10A shows a tilt angle before the change, and FIG. 10B shows the tilt angle after the change.

FIG. 11 is a partial enlarged view of the angle change mechanism according to the third embodiment.

FIG. 12 is a partial enlarged view of an angle change mechanism according to a modification example.

FIG. 13 is a partial enlarged view of an angle change mechanism according to a modification example.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

### (Configuration of Liquid Crystal Television Device 100)

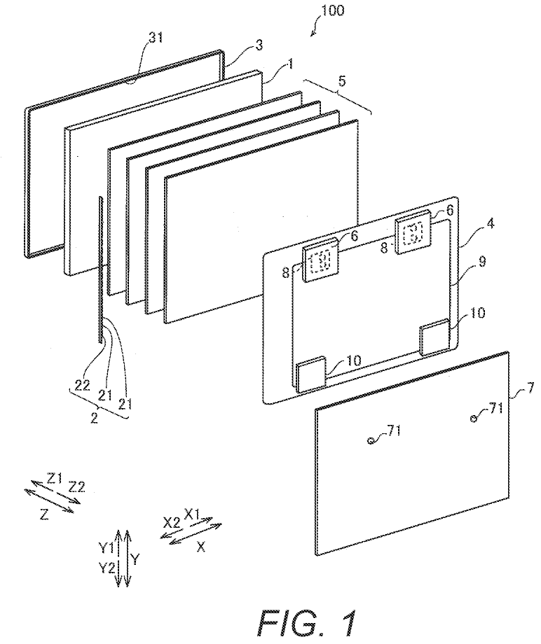

Referring to FIGS. 1 to 3, the configuration of a liquid crystal television device 100 according to a first embodiment will be described. The liquid crystal television device 100 is an example of a “display device” of the present disclosure.

As shown in FIG. 1, the liquid crystal television device 100 has a display unit 1 (e.g., a display), a light source 2, a front frame 3, a rear frame 4, a sheet member 5, one or more (two in FIG. 1) height speakers 6 (e.g., a speaker and an additional speaker), a cover member 7, one or more (two in FIG. 1) angle change mechanisms 8 (e.g., an angle change mechanism and an additional angle change mechanism), a substrate 9, and one or more (two in FIG. 1) main speakers 10. Since there is little or no difference in the structure of the left and right height speakers 6, these height speakers 6 are not distinguished in the following explanation. Thus, the description about one of the height speakers 6 can be applied to the other one of the height speakers 6. Similarly, there is little or no difference in the structure of the left and right main speakers 10, these main speakers 10 are not distinguished in the following explanation. Thus, the description about one of the main speakers 10 can be applied to the other one of the main speakers 10. The height speakers are an example of a “speaker” of the present disclosure.

The display unit 1 includes a liquid crystal cell. The display unit 1 includes a plurality of pixels, and each of the pixels changes the transmittance of light irradiated from the light source 2 to display an image on a display surface of the display unit 1. The display unit 1 is driven based on video or image signals. The display unit 1 is rectangular in shape. The display surface side of the display unit 1 on which the image is displayed is referred to as a front side (Z1 side), and the opposite side of the Z1 side is referred to as a rear side (Z2 side). The thickness direction of the display unit 1 connecting the front side and the rear side is referred to as a Z direction. The longitudinal direction (left-right direction) of the display unit 1 orthogonal to the Z direction is referred to as an X direction, and the shortitudinal direction (up-down direction) of the display unit 1 orthogonal to the Z direction is referred to as a Y direction. In the X direction, the right side when looking at the front side from the rear side is referred to as an X1 side, and the left side is referred to as an X2 side. In the Y direction, the upper end side of the display unit 1 is referred to as a Y1 side, and the lower end side is referred to as a Y2 side.

The light source 2 is located on the X2 side of the display unit 1. The light source 2 is configured to irradiate the display unit 1 with light. The light source 2 includes a plurality of LEDs 21 and a light source substrate 22. Of course, the liquid crystal television device 100 can include different types of light sources as needed and/or desired.

The front frame 3 is rectangular in shape. The length of the front frame 3 in the up-down direction (Y direction) is larger than the length of the display unit 1 in the up-down direction (Y direction). The length of the front frame 3 in the left-right direction (X-direction) is larger than the length of the display unit 1 in the left-right direction (X-direction). The front frame 3 is configured to support the display unit 1 from the front side (Z1 side). A rectangular-shaped opening 31 is provided in the center portion of the front frame 3 to expose the display surface of the display unit 1 toward the front side (Z1 side).

The rear frame 4 is rectangular in shape. The rear frame 4 is located on the rear side (Z2 side) of the display unit 1. The length of the rear frame 4 in the up-down direction (Y direction) is smaller than the length of the front frame 3 in the up-down direction (Y direction). The length of the rear frame 4 in the left-right direction (X-direction) is smaller than the length of the front frame 3 in the left-right direction (X-direction). Therefore, the outer peripheral surface of the rear frame 4 is fixed in contact with the inner peripheral surface of the front frame 3.

The sheet member 5 is provided between the display unit 1 and the rear frame 4. The sheet member 5 includes a plurality of sheets, such as optical sheets. The sheet member 5 includes, for example, a reflective sheet that reflects light irradiated from the light source 2 and a diffusion sheet that diffuses the irradiated light toward the display unit 1.

As shown in FIG. 1, the height speakers 6 are provided on the upper side or upper portion of the rear frame 4. The height speakers 6 are provided on the left side (X2 side) and the right side (X1 side) of the rear frame 4, respectively. The height speakers 6 each include a vibration unit, a magnet, and a coil, although not shown. The height speakers 6 output sound when vibrations are generated by the coils and the magnets and further vibrated by the vibration units. The vibration units are placed on the output sides of the height speakers 6 where the sound is output. The magnets are placed on the opposite sides of the output sides. In the first embodiment, the height speakers 6 are mounted on the rear frame 4 so that the output sides where the sound is output are located on the Y1 side.

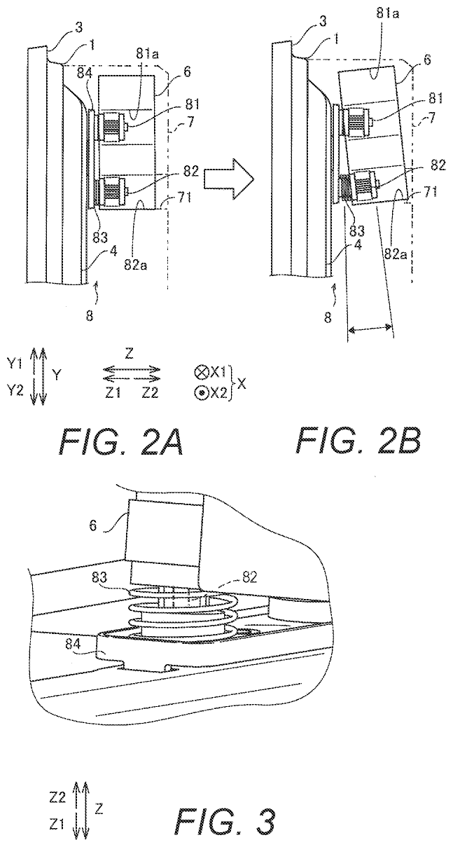

As shown in FIGS. 2A and 2B, the height speakers 6 each have an upper portion that is fixed to the rear frame 4 by a first screw 81. The height speakers 6 each have a first through hole 81a at the upper portion. The first through hole 81a has an inner diameter larger than an outer diameter of the first screw 81, and the first screw 81 is inserted into the first through hole 81a. The first through holes 81a extend through the height speakers 6 in the Z direction. The first screws 81 cannot be loosened when the cover member 7 is installed. The height speakers 6 are swingably or pivotally coupled to the rear frame 4 via the first screws 81. The height speakers 6 each have a lower portion that is fixed to the rear frame 4 by a second screw 82. The height speakers 6 each have a second through hole 82a in the lower portion for inserting the second screw 82. The second through hole 82a extends through the height speakers 6 in the Z direction.

As shown in FIG. 1, the cover member 7 is rectangular in shape. The length of the cover member 7 in the up-down direction (Y direction) is substantially the same as the length of the rear frame 4 in the up-down direction (Y direction). The length of the cover member 7 in the left-right direction (X direction) is substantially the same as the length of the rear frame 4 in the left-right direction (X direction). The cover member 7 covers the height speakers 6, the main speakers 10 and the substrate 9. In the illustrated embodiment, the cover member 7 entirely covers the rear frame 4 to which the height speakers 6, the main speakers 10 and the substrate 9 are attached. As shown in FIGS. 1, 2A and 2B, the cover member 7 includes a pair of third through holes 71. The third through holes 71 are provided at positions corresponding to the second through holes 82a of the height speakers 6. The second screws 82 can be accessed and operated through the third through holes 71 from outside the cover member 7, respectively. In particular, the second screws 82 are loosened or tightened from outside the cover member 7 through the third through holes 71, respectively. In FIGS. 2A and 2B, the cover member 7 is shown in double-dotted lines for convenience. The third through holes 71 extend through the cover member 7 in the Z direction. The cover member 7 may be provided with a hole for outputting sound.

As shown in FIGS. 1, 2A and 2B, the angle change mechanisms 8 are provided to change the tilt angles of the height speakers 6 that are located inside the cover member 7 relative to the rear frame 4 from outside of the cover member 7 in a state in which the height speakers 6 are covered by the cover member 7. The detailed configurations of the angle change mechanisms 8 are described later.

As shown in FIG. 1, the substrate 9 is mounted on the rear frame 4. The substrate 9 has a control circuit that is mounted thereon. With the substrate 9, the mounted control circuit is electrically connected to the display unit 1, the height speakers 6 and the main speakers 10. The substrate 9 outputs audio signals to the height speakers 6 and the main speakers 10 by the control circuit, and outputs video or image signals to the display unit 1.

The main speakers 10 are provided at the lower portion of the rear frame 4. The main speakers 10 are provided on the left side (X2 side) and the right side (X1 side) of the rear frame 4, respectively. The main speakers 10 each include a vibration unit, a magnet and a coil, although not shown. The main speakers 10 output sound when vibrations are generated by the coils and the magnets and further vibrated by the vibration units. The vibration units are placed on the output sides of the main speakers 10 where the sound is output. The magnets are placed on the opposite sides of the output sides. In this embodiment, the main speakers 10 are mounted on the rear frame 4 so that the output sides where the sound is output are located on the Y1 side.

### (Structure of Angle Change Mechanism)

As shown in FIGS. 2A, 2B and 3, the angle change mechanisms 8 each have a biasing member 83. The second screws 82 are inserted into the biasing members 83 to constrain or restrict the biasing members 83, respectively. The biasing members 83 are positioned between the height speakers 6 and the rear frame 4 and also bias the height speaker 6 rearward relative to the rear frame 4 or away from the rear frame 4 (in the Z2 direction). Specifically, the biasing members 83 are positioned between the height speakers 6 and the rear frame 4 in a compressed state in which the biasing members 83 are compressed and restricted by the second screws 82. The angle change mechanisms 8 each have a mounting member or plate 84 that is attached to the rear frame 4. The biasing members 83 are positioned between the mounting members 84 and the height speakers 6, respectively. The biasing members 83 each include, for example, a coil spring. Of course, the biasing members 83 can include different types of springs as needed and/or desired.

The height speakers 6 are secured to the mounting members 84 by the first screws 81 and the second screws 82, respectively. The mounting members 84 are engaged to the rear frame 4. Specifically, the mounting members 84 each have threaded holes to which the first screw 81 and the second screw 82 are threaded to secure the respective one of the height speakers 6.

FIG. 2A shows a state in which the height speakers 6 are mounted on the rear frame 4 during assembly (initial state) of the liquid crystal television device 100. During the assembly, the height speakers 6 are attached to the rear frame 4 at a minimum tilt angle. Specifically, in this initial state, the second screws 82 are tightened to the mounting members 84 to compress the biasing members 83, respectively. Then, as shown in FIG. 2B, the tilt angles of the height speakers 6 with respect to the rear frame 4 are changed by loosening the second screws 82, respectively. While the second screws 82 are being loosened by the user, the forces exerted by the biasing members 83 trying to expand back to their equilibrium length or resting position bias the height speakers 6 rearward relative to the rear frame 4 and the biasing members 83 are expanded. As a result, the lower portions of the height speakers 6 are pushed rearward to increase the distance (distance in the Z direction) between the lower portions of the height speakers 6 and the rear frame 4, and the upper portions of the height speakers 6 tilt forward with respect to the first screws 81. This increases the forward tilt angles of the height speakers 6 relative to the rear frame 4 with respect to the vertical direction. The second screws 82 can be loosened or tightened, for example, with a tool such as a screwdriver. The second through holes 82a and the third through holes 71 are set in diameter so that the tool can be inserted to loosen or tighten the second screws 82.

### Effect of First Embodiment

The first embodiment has the following effects.

As described above, the liquid crystal television device 100 is provided with the cover member 7 that covers the height speakers 6. As a result, it is possible to prevent foreign matter from adhering to the height speakers 6. The liquid crystal television device 100 is also provided with the angle change mechanisms 8 for changing the tilt angles of the height speakers 6 positioned inside the cover member 7 with respect to the rear frame 4 from outside the cover member 7 while the height speakers 6 are covered by the cover member 7. This allows the tilt angles of the height speakers 6 with respect to the rear frame 4 to be adjusted without removing the cover member 7. As a result, the adhesion of foreign matter to the height speakers 6 can be prevented and the tilt angles of the height speakers 6 can be changed.

As described above, the height speakers 6 have the upper portions that are fixed to the rear frame 4 by the first screws 81. The height speakers 6 have the first through holes 81a that have the inner diameter larger than the outer diameter of the first screws 81 and into which the first screws 81 are inserted. The angle change mechanisms 8 are configured to tilt the upper portions of the height speakers 6 relative to the first screws 81 and configured to change the distance between the lower portions of the height speakers 6 and the rear frame 4. In this configuration, by changing the distance between the lower portions of the height speakers 6 and the rear frame 4, the height speakers 6 can be tilted so that the sound is directed toward a user in a position facing the front surface of the display unit 1. Furthermore, the height speakers 6 have the first through holes 81a that have the inner diameter larger than the outer diameter of the first screws 81 and into which the first screws 81 are inserted, which allows the height speakers 6 to be tilted with respect to the rear frame 4 while maintaining a state in which the height speakers 6 are fixed to the rear frame 4.

As described above, the angle change mechanisms 8 are configured to change the tilt angles of the height speakers 6 in the front-rear direction relative to the vertical direction while the height speakers 6 are covered by the cover member 7. In this configuration, the height speakers 6 can be tilted so that the sound is directed toward the user in the position facing the front surface of the display unit 1 by tilting in the front-rear direction relative to the vertical direction while the height speakers 6 are covered by the cover member 7.

As described above, the height speakers 6 have the lower portions that are fixed to the rear frame 4 by the second screws 82. The height speakers 6 have the second through holes 82a into which the second screws 82 are inserted. The angle change mechanisms 8 have the biasing members 83 that are disposed between the height speakers 6 and the rear frame 4 to bias the height speakers 6 away from the rear frame. The second screws 82 are inserted into the biasing members 83 to constrain the biasing members 83. The angle change mechanism 8 are configured to increase the tilt angles of the height speakers 6 with respect to the rear frame 4 as loosening the second screws 83. In this configuration, the user can easily change the tilt angles of the height speakers 6 with respect to the rear frame 4 because the tilt angles of the height speakers 6 with respect to the rear frame 4 are changed by loosening the second screws 82.

As described above, the cover member 7 has the third through holes 71 at positions corresponding to the second through holes 82a of the height speakers 6 for accessing the second screws 82 from outside the cover member 7. In this configuration, the user can easily change the tilt angles of the height speakers 6 relative to the rear frame 4 via the third through holes 71 even when the height speakers 6 are covered by the cover member 7.

### Second Embodiment

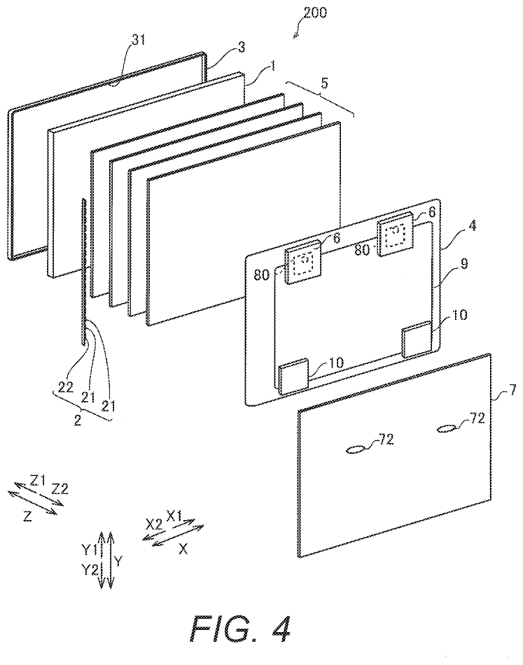

Next, the configuration of one or more (two in FIG. 4) angle change mechanisms 80 according to a second embodiment will be described with reference to FIGS. 4 to 8. In a liquid crystal television device 200 of the second embodiment, unlike the first embodiment, the third through holes 71 are not provided in the cover member 7. Instead, the cover member 7 includes one or more (two in FIG. 4) slots or long holes 72.

As shown in FIG. 4, the long holes 72 are provided on the rear side of the cover member 7. The long holes 72 have, for example, an oval shape. The long holes 72 are through holes penetrating the cover member 7 in the Z direction.

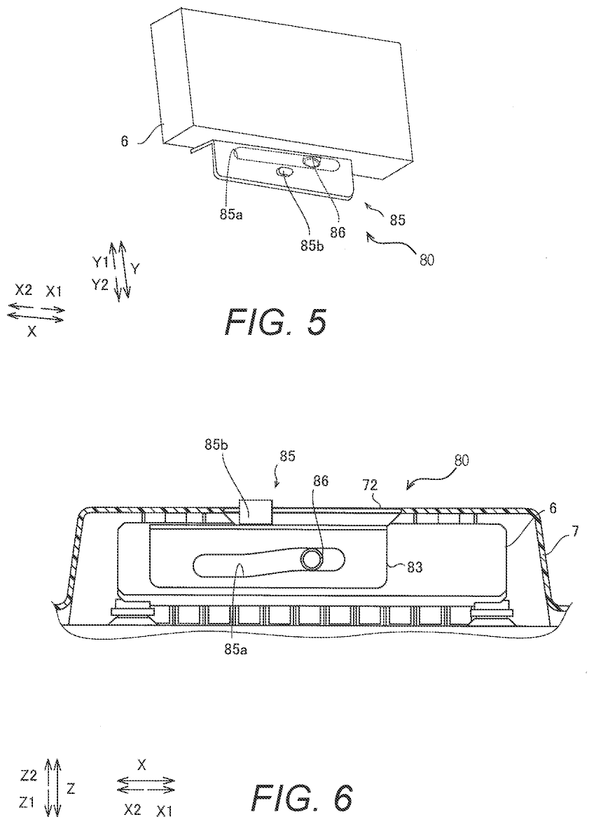

As shown in FIGS. 5 and 6, the angle change mechanisms 80 each include a cam and follower mechanism. Specifically, the angle change mechanisms 80 each include a movable plate 85 and a protruding portion or pin 86. The movable plates 85 are movably attached to the bottom sides (Y2 side) of the height speakers 6. The movable plates 85 are L-shaped. In particular, the movable plates 85 each include an L-shaped bracket. The movable plates 85 include grooves or grooved cams 85a on the bottom sides (Y2 side) of the movable plates 85, respectively. The grooves 85a slope in a front-rear direction when viewed from the bottom surface. In particular, as seen in FIG. 6, the movable plates 85 are movable or slidable along the X direction, and the grooves 85a each have a portion inclined with respect to the X direction or the moving direction of the movable plates 85. In the illustrated embodiment, the grooves 85a are inclined toward the rear frame 4 in the Z direction as moving leftward (X2 side).

The protruding portions 86 are provided on the bottom sides or surfaces of the height speakers 6. The protruding portions 86 protrude downwardly from the bottom surfaces of the height speakers 6. The protruding portions 86 are engaged with the grooves 85a, respectively. The movable plates 85, which are provided with the grooves 85a, move in the left-right direction while being engaged with the protruding portions 86, respectively.

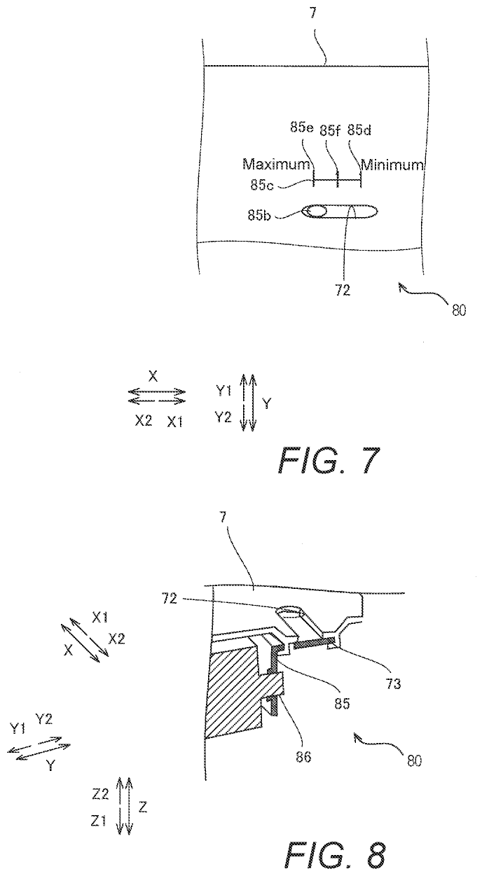

As shown in FIGS. 6 and 7, the movable plates 85 include operation parts 85b on the rear sides of the movable plates 85, respectively. The operation parts 85b each include, for example, an oval, circular or polygonal shaped knob. The operation parts 85 are disposed through the long holes 72 of the cover member 7. Thus, the operation parts 85b can be operated from the rear side through the long holes 72. In the illustrated embodiment, the long holes 72 have a width of about 0.5 cm to 2 cm, for example, to operate the operation parts 85b with a thumb. In the second embodiment, the operation parts 85b are operated to move (slide) the movable plates 85 in the X direction, respectively.

As shown in FIG. 8, the movable plates 85 are movably or slidably attached to rail sections 73 provided to the cover member 7. As a result, the movable plates 85 move in the X direction along the rail sections 73. The movable plates 85 are restricted from moving in the Y direction and the Z direction by the rail sections 73 provided to the cover member 7. Of course, the movable plates 85 can be movably or slidably attached to the cover member 7 in a different manner, as needed and/or desired.

As shown in FIG. 7, the cover member 7 includes one or more (two in the illustrated embodiment) marks 85c that are provided above the long holes 72, respectively. The marks 85c each include, for example, scales 85d, 85e and 85f. The scales 85d are located at the rightmost in the marks 85c when viewed from the rear side, and are marked as “Minimum”, which indicates that the tilt angles of the height speakers 6 relative to the rear frame 4 is minimum when the operation parts 85b are positioned at the scales 85d. The scales 85e are located at the leftmost in the marks 85c, are marked as “Maximum”, which indicates that the tilt angles of the height speakers 6 relative to the rear frame 4 is maximum when the operation parts 85b are positioned at the scales 85e. The center scales 85f indicate that the tilt angles are half of the maximum tilt angles, respectively, when the operation parts 85b are positioned at the center scales 85f. For example, if the maximum tilt angles are 20 degrees, the tilt angles of the height speakers 6 relative to the rear frame 4 are half of that value, 10 degrees, when the operation parts 85b are positioned at the center scales 85f.

When the operation parts 85b are operated (slid in the X direction) by the user, the movable plates 85 move in the left-right direction, respectively. As the movable plates 85 move, the protruding portions 86 move along the grooves 85a, respectively. Since the grooves 85a are inclined in the front-rear direction with respect to the left-right direction, the protruding portions 86 also move in the front-rear direction in accordance with their positions along the grooves 85a. For example, when the operation parts 85b are moved from the X1 side to the X2 side, the height speakers 6 (the lower portions of the height speakers 6) move rearward. When the protruding portions 86 move rearward, the distances between the lower portions of the height speakers 6 and the rear frame 4 increase. In this case, the height speakers 6 are tilted forward with respect to the vertical direction. The X2 side ends of the grooves 85a represent the positions where the tilt angles between the rear frame 4 and the height speakers 6 become a minimum tilt angle, while the X1 side ends of the grooves 85a represent the positions where the title angles between the rear frame 4 and the height speakers 6 become a maximum tilt angle.

Other configurations of the second embodiment are the same as the first embodiment above. For example, the upper portions of the height speakers 6 are attached in the same manner as in the first embodiment. In particular, the upper portions of the height speakers 6 are swingably or pivotally coupled to the rear frame 4 via the first screws 81.

### Effect of Second Embodiment

In the second embodiment, as in the first embodiment above, the liquid crystal television device 200 is provided with the cover member 7 that covers the height speakers 6. As a result, it is possible to prevent foreign matter from adhering to the height speakers 6. The liquid crystal television device 200 is also provided with the angle change mechanisms 80 for changing the tilt angles of the height speakers 6 positioned inside the cover member 7 with respect to the rear frame 4 from outside the cover member 7 while the height speakers 6 are covered by the cover member 7. This allows the tilt angles of the height speakers 6 with respect to the rear frame 4 to be adjusted without removing the cover member 7. As a result, the adhesion of foreign matter to the height speakers 6 can be prevented and the tilt angles of the height speakers 6 can be changed.

In the second embodiment, the angle change mechanisms 80 include the marks 85c that indicate the tilt angles of the height speakers 6 with respect to the rear frame 4, respectively, and are visible from outside the cover member 7. This allows the user to easily visually confirm the tilt angles of the height speakers 6 with respect to the rear frame 4 even when the height speakers 6 cannot be directly seen by the cover member 7.

In the second embodiment, the angle change mechanisms 80 include the protruding portions 86 that protrude from the bottom surfaces of the height speakers 6, and the movable plates 85 that have the grooves 85a into which the protruding portions 86 are inserted and that are inclined in the front-rear direction as viewed from the bottom surface of the height speakers 6, and the operation parts 85b that protrude toward the cover member 7. The angle change mechanisms 80 are configured to change the tilt angles of the height speakers 6 with respect to the rear frame 4 in response to the operation parts 85b being operated to move the movable plates 85 and to change the positions of the protruding portions 86 along the grooves 85a. In this configuration, the user can easily change the tilt angles of the height speakers 6 with respect to the rear frame 4 because the tilt angles of the height speakers 6 with respect to the rear frame 4 are changed by the user operating the operation parts 85b.

In the second embodiment, the cover member 7 includes the long holes 72 through which the operation parts 85b are accessed and operated from the outside. This configuration allows the user to easily change the tilt angles of the height speakers 6 with respect to the rear frame 4 via the long holes 72 even when the height speakers 6 are covered by the cover member 7.

The other effects of the second embodiment are the same as those of the first embodiment.

### Third Embodiment

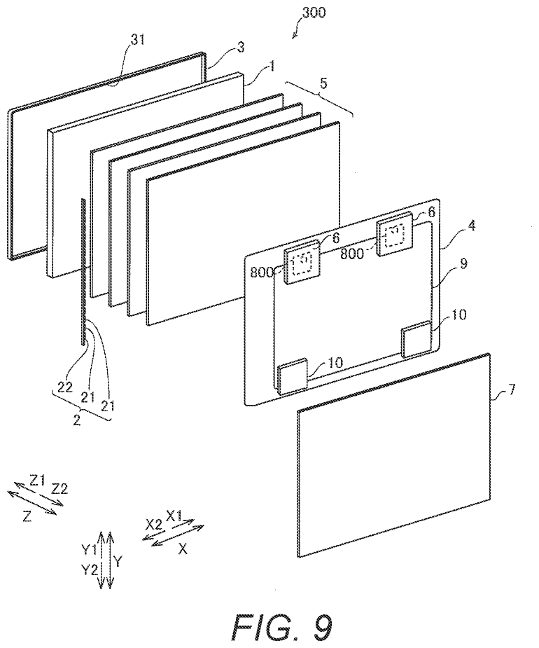

Next, the configuration of one or more (two in FIG. 9) angle change mechanisms 800 according to a third embodiment will be described with reference to FIGS. 9 to 11. In a liquid crystal television device 300 of the third embodiment, unlike the first and second embodiments, the angle change mechanisms 800 each have a pinion gear 87.

As shown in FIG. 9, the cover member 7 has no through holes.

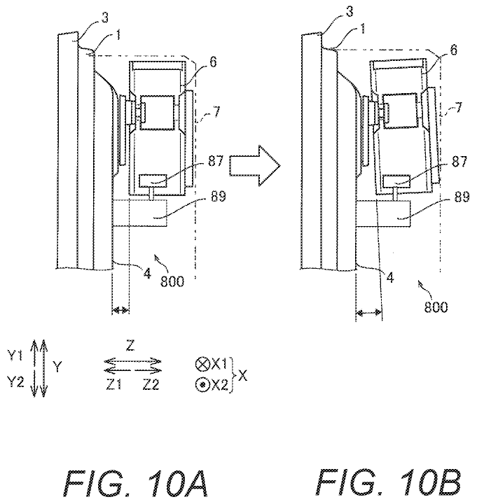

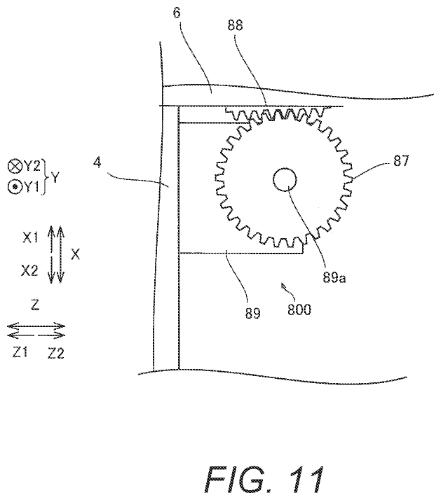

As shown in FIGS. 10A and 10B and 11, the angle change mechanisms 800 each include a pinion gear 87, a rack gear 88, and a drive unit 89. The pinion gears 87 are a spur gear, for example. The pinion gears 87 are attached to the rear frame 4. Specifically, the pinion gears 87 are rotatably attached to the rear frame 4 via the drive units 89, respectively.

The rack gears 88 are located on side surfaces of the lower portions of the height speakers 6, respectively. The rack gears 88 are engaged with the pinion gears 87, respectively. In the illustrated embodiment, the rack gears 88 are integrated with the lower portions of the height speakers 6, respectively.

The drive units 89 are operatively coupled to the pinion gears 87, respectively. The drive units 89 rotate the pinion gears 87, respectively. The drive units 89 include, for example, an electric motor or actuator. The drive units 89 are located below the pinion gears 87, respectively, and are fixedly attached to the rear frame 4. The pinion gears 87 are fixedly attached to the rotational shafts of the drive units 89, respectively.

In the illustrated embodiment, the drive units 89 are remotely controllable using a remote control for operating the liquid crystal television device 300. Thus, the user sets the tilt angles of the height speakers 6 with respect to the rear frame 4 using the remote control for operating the liquid crystal television device 300. Specifically, the tilt angles can be gradually or stepwisely settable or changeable, or can be set by selecting one rotation mode from multiple rotation modes.

FIG. 10A shows an initial state in which the tilt angles of the height speakers 6 with respect to the rear frame 4 are at minimum, and FIG. 10B shows a state in which the tilt angles of the height speakers 6 with respect to the rear frame 4 are at maximum. The pinion gears 87 rotate when the drive units 89 are driven. As the pinion gears 87 rotate, the rack gears 88 meshed with the pinion gears 87 move linearly in the Z direction. The linear movements of the rack gears 88 move the lower portions of the height speakers 6 rearward (Z2 side), and the distances between the lower portions of the height speakers 6 and the rear frame 4 increase. On the other hand, since the upper portions of the height speakers 6 are swingably or pivotally attached to the rear frame 4, the height speakers 6 are tilted with respect to the rear frame 4.

Other configurations of the third embodiment are the same as the first embodiment above. For example, the upper portions of the height speakers 6 are attached in the same manner as in the first embodiment. In particular, the upper portions of the height speakers 6 are swingably or pivotally coupled to the rear frame 4 via the first screws 81.

### Effect of Third Embodiment

In the third embodiment, as in the first embodiment above, the liquid crystal television device 300 is provided with the cover member 7 that covers the height speakers 6. As a result, it is possible to prevent foreign matter from adhering to the height speakers 6. The liquid crystal television device 300 is also provided with the angle change mechanisms 800 for changing the tilt angles of the height speakers 6 positioned inside the cover member 7 with respect to the rear frame 4 from outside the cover member 7 while the height speakers 6 are covered by the cover member 7. This allows the tilt angles of the height speakers 6 with respect to the rear frame 4 to be adjusted without removing the cover member 7. As a result, the adhesion of foreign matter to the height speakers 6 can be prevented and the tilt angles of the height speakers 6 can be changed.

In the third embodiment, the angle change mechanisms 800 include the rack gears 88 that are located in the lower portions of the height speakers 6, the pinion gears 87 that are engaged with the rack gears 88, and the drive units 89 that are configured to rotate the pinion gears 87. The angle change mechanisms 800 are configured to change the tilt angles of the height speakers 6 with respect to the rear frame 4 as the rack gears 88 linearly move in response to rotations of the pinion gears 87 by the drive units 89, respectively. In this configuration, the user does not need to manually change the tilt angles of the height speakers 6 because the tilt angles of the height speakers 6 with respect to the rear frame 4 are changed by driving the drive units 89, respectively. As a result, for example, if the drive units 89 can be driven by operating a remote control attached to the liquid crystal television device 300, a user viewing from the front side of the display unit 1 (the front side of the liquid crystal television device 300) can change the tilt angles of the height speakers 6 from the viewing position without moving to the rear side of the liquid crystal television device 300 and adjusting the angle change mechanisms 800 provided on the rear side of the liquid crystal television device 300 to manually change the tilt angles of the height speakers 6.

The other effects of the third embodiment are the same as those of the first embodiment.

### MODIFICATIONS

The embodiments disclosed herein are just examples in every respect, and should not be interpreted as being limiting in nature. The scope of the invention being indicated by the claims rather than by the above description of the embodiments, all modifications (modification examples) within the meaning and range of equivalency of the claims are included.

For example, in the first to third embodiments, examples are shown in which the angle change mechanisms 8, 80 and 800 change the tilt angles of the height speakers 6 with respect to the rear frame 4, but the invention is not limited to this. For example, the angle change mechanisms 8, 80 and 800 may be configured to change the tilt angles of the main speakers 10 with respect to the rear frame 4.

In the first embodiment above, an example is shown in which the biasing members 83 include a coil spring, but the invention is not limited to this. For example, the biasing members 83 may include a plate spring.

In the second embodiment above, an example is shown in which the angle change mechanisms 80 include the marks 85c, but the invention is not limited to this. For example, the angle change mechanisms 8 of the first embodiment may have the marks, and for example, some of the screws may have the marks.

In the second embodiment above, an example is shown in which the grooves 85a are inclined, but the invention is not limited to this. For example, the grooves 85a may be formed stepwisely.

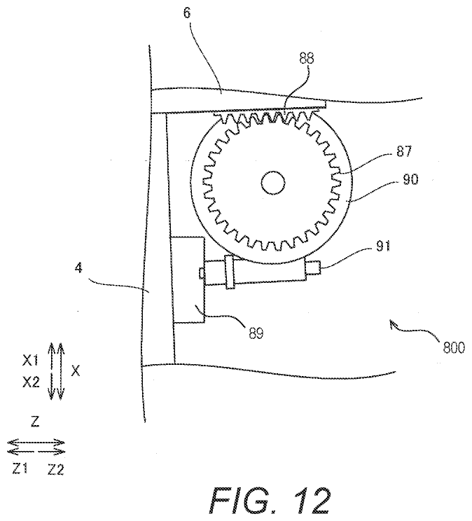

In the third embodiment above, the angle change mechanisms 800 include a rack and pinion mechanism, but the invention is not limited to this. For example, the angle change mechanisms 800 may each include a worm wheel 90 and a worm gear 91, as shown in FIG. 12. In this case, the drive units 89 attached to the rear frame 4 are configured to rotate the worm gears 91. The rotations of the worm gears 91 rotate the pinion gears 87 via the worm wheels 90, respectively, thereby linearly moving the rack gears 88 and adjusting the tilt angles of the height speakers 6. This increases the reduction ratio, allowing fine adjustment of the tilt angles and smooth and silent movement.

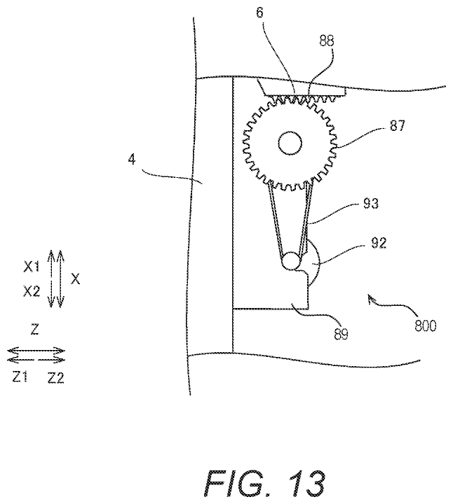

In the third embodiment above, the angle change mechanisms 800 include a rack and pinion mechanism, but the invention is not limited to this. For example, the angle change mechanisms 800 may each include a pulley 92 and a belt 93, as shown in FIG. 13. In this case, the drive units 89 attached to the rear frame 4 are configured to rotate the pulleys 92. The rotations of the pulleys 92 rotate the pinion gears 87, which are connected to the pulleys 92 via the belts 93, respectively, thereby linearly moving the rack gears 88 and adjusting the tilt angles of the height speakers 6. This increases the reduction ratio, allowing fine adjustment of the tilt angles and smooth and silent movement.

In view of the state of the known technology, a display device according to one aspect of the present disclosure comprises a display, a rear frame disposed on a rear side of the display, a speaker attached to the rear frame such that a tilt angle of the speaker with respect to the rear frame is changeable, a cover member attached to the rear frame to cover the speaker such that the speaker is located inside the cover member, and an angle change mechanism configured to change the tilt angle of the speaker with respect to the rear frame from outside the cover member while the speaker is covered by the cover member.

The display device according to one aspect of the present disclosure has the cover member covering the speaker as mentioned above. As a result, foreign matter can be prevented from adhering to the speaker. In addition, the display device has the angle change mechanism for changing the tilt angle of the speaker, which is located inside the cover member, with respect to the rear frame from outside the cover member while the speaker is covered by the cover member. This allows the tilt angle of the speaker with respect to the rear frame to be adjusted without removing the cover member. As a result, adhesion of foreign matter to the speaker can be prevented and the tilt angle of the speaker can be changed.

In accordance with a preferred embodiment according to the display device mentioned above, the speaker has an upper portion that is fixed to the rear frame by a first screw. The speaker has a first through hole that has an inner diameter larger than an outer diameter of the first screw and into which the first screw is inserted. The angle change mechanism is configured to tilt the upper portion of the speaker with respect to the first screw and configured to change a distance between a lower portion of the speaker and the rear frame. In this configuration, by changing the distance between the lower portion of the speaker and the rear frame, the speaker can be tilted so that the sound is directed toward a user in a position facing a front surface of the display. Furthermore, the speaker has the first through hole that has the inner diameter larger than the outer diameter of the first screw and into which the first screw is inserted, which allows the speaker to be tilted with respect to the rear frame while maintaining a state in which the speaker is fixed to the rear frame.

In accordance with a preferred embodiment according to any one of the display devices mentioned above, the angle change mechanism includes a mark that indicates the tilt angle of the speaker with respect to the rear frame and is visible from outside the cover member. This configuration allows the user to easily visually confirm the tilt angle of the speaker with respect to the rear frame even when the speaker cannot be directly seen by the cover member.

In accordance with a preferred embodiment according to any one of the display devices mentioned above, the angle change mechanism is configured to change the tilt angle of the speaker in a front-rear direction relative to a vertical direction while the speaker is covered by the cover member. In this configuration, the speaker can be tilted so that the sound is directed toward a user in a position facing a front surface of the display by tilting in the front-rear direction relative to the vertical direction while the speaker is covered by the cover member.

In accordance with a preferred embodiment according to any one of the display devices mentioned above, the speaker has a lower portion that is fixed to the rear frame by a second screw. The speaker has a second through hole into which the second screw is inserted. The angle change mechanism has a biasing member that is disposed between the speaker and the rear frame to bias the speaker away from the rear frame. The second screw is inserted into the biasing member to constrain the biasing member. The angle change mechanism is configured to increase the tilt angle of the speaker with respect to the rear frame as loosening the second screw. In this configuration, the user can easily change the tilt angle of the speaker with respect to the rear frame because the tilt angle of the speaker with respect to the rear frame is changed by loosening the second screw.

In accordance with a preferred embodiment according to any one of the display devices mentioned above, the cover member has a third through hole at a position corresponding to the second through hole of the speaker for accessing the second screw from outside the cover member. In this configuration, the user can easily change the tilt angle of the speaker relative to the rear frame via the third through hole even when the speaker is covered by the cover member.

In accordance with a preferred embodiment according to any one of the display devices mentioned above, the angle change mechanism includes a protruding portion that protrudes from a bottom surface of the speaker, and a movable plate that has a groove into which the protruding portion is inserted and that is inclined in a front-rear direction as viewed from the bottom surface of the speaker, and an operation part that protrudes toward the cover member. The angle change mechanism is configured to change the tilt angle of the speaker with respect to the rear frame in response to the operation part being operated to move the movable plate and to change a position of the protruding portion along the groove. In this configuration, the user can easily change the tilt angle of the speaker with respect to the rear frame because the tilt angle of the speaker with respect to the rear frame is changed by the user operating the operation part.

In accordance with a preferred embodiment according to any one of the display devices mentioned above, the cover member includes a slot through which the operation part is accessed and operated from outside. This configuration allows the user to easily change the tilt angle of the speaker with respect to the rear frame via the slot even when the speaker is covered by the cover member.

In accordance with a preferred embodiment according to any one of the display devices mentioned above, the angle change mechanism has a rack gear that is located at a lower portion of the speaker, a pinion gear that is engaged with the rack gear, and a drive unit that is configured to rotate the pinion gear. The angle change mechanism is configured to change the tilt angle of the speaker with respect to the rear frame as the rack gear linearly moves in response to a rotation of the pinion gear by the drive unit. In this configuration, the user does not need to manually change the tilt angle of the speaker because the tilt angle of the speaker with respect to the rear frame is changed by driving the drive unit. As a result, for example, if the drive unit can be driven by operating a remote control attached to the display device, a user viewing from the front side of the display surface (the front side of the display device) can change the tilt angle of the speaker from the viewing position without moving to the rear side of the display device and adjusting the angle change mechanism provided on the rear side of the display device to manually change the tilt angle of the speaker.

According to the present disclosure, as described above, it is possible to provide a display device that can prevent foreign matter from adhering to a speaker and can change the angle of the speaker.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a display device in an upright position on a horizontal surface.

Accordingly, these directional terms, as utilized to describe the display device should be interpreted relative to a display device on a horizontal surface. The terms “left” and “right” are used to indicate the “right” when referencing from the right side as viewed from the rear side of the display device, and the “left” when referencing from the left side as viewed from the rear side of the display device.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A display device comprising:
a display;
a rear frame disposed on a rear side of the display;
a speaker attached to the rear frame such that a tilt angle of the speaker with respect to the rear frame is changeable;
a cover member attached to the rear frame to cover the speaker such that the speaker is located inside the cover member; and
an angle change mechanism configured to change the tilt angle of the speaker with respect to the rear frame from outside the cover member while the speaker is covered by the cover member.

2. The display device according to claim 1, wherein
the speaker has an upper portion that is fixed to the rear frame by a first screw.

3. The display device according to claim 2, wherein
the speaker has a first through hole that has an inner diameter larger than an outer diameter of the first screw and into which the first screw is inserted.

4. The display device according to claim 3, wherein
the angle change mechanism is configured to tilt the upper portion of the speaker with respect to the first screw and configured to change a distance between a lower portion of the speaker and the rear frame.

5. The display device according to claim 1, wherein
the angle change mechanism includes a mark that indicates the tilt angle of the speaker with respect to the rear frame and is visible from outside the cover member.

6. The display device according to claim 1, wherein
the angle change mechanism is configured to change the tilt angle of the speaker in a front-rear direction relative to a vertical direction while the speaker is covered by the cover member.

7. The display device according to claim 2, wherein
the speaker has a lower portion that is fixed to the rear frame by a second screw.

8. The display device according to claim 7, wherein
the speaker has a second through hole into which the second screw is inserted.

9. The display device according to claim 8, wherein
the angle change mechanism has a biasing member that is disposed between the speaker and the rear frame to biases the speaker away from the rear frame.

10. The display device according to claim 9, wherein
the second screw is inserted into the biasing member to constrain the biasing member.

11. The display device according to claim 10, wherein
the angle change mechanism is configured to increase the tilt angle of the speaker with respect to the rear frame as loosening the second screw.

12. The display device according to claim 10, wherein
the cover member has a third through hole at a position corresponding to the second through hole of the speaker for accessing the second screw from outside the cover member.

13. The display device according to claim 2, wherein
the angle change mechanism includes
a protruding portion that protrudes from a bottom surface of the speaker, and
a movable plate that has a groove into which the protruding portion is inserted and that is inclined in a front-rear direction as viewed from the bottom surface of the speaker, and an operation part that protrudes toward the cover member.

14. The display device according to claim 13, wherein
the angle change mechanism is configured to change the tilt angle of the speaker with respect to the rear frame in response to the operation part being operated to move the movable plate and to change a position of the protruding portion along the groove.

15. The display device according to claim 13, wherein
the cover member includes a slot through which the operation part is accessed and operated from outside.

16. The display device according to claim 2, wherein
the angle change mechanism includes
a rack gear that is located at a lower portion of the speaker,
a pinion gear that is engaged with the rack gear, and
a drive unit that is configured to rotate the pinion gear.

17. The display device according to claim 16, wherein
the angle change mechanism is configured to change the tilt angle of the speaker with respect to the rear frame as the rack gear linearly moves in response to a rotation of the pinion gear by the drive unit.

18. The display device according to claim 1, further comprising
an additional speaker attached to the rear frame such that a tilt angle of the additional speaker with respect to the rear frame is changeable, and
an additional angle change mechanism configured to change the tilt angle of the additional speaker with respect to the rear frame from outside the cover member while the additional speaker is covered by the cover member.

19. The display device according to claim 18, wherein
the speaker and the additional speaker are disposed inside the cover member.

20. The display device according to claim 1, wherein
the speaker is attached to an upper portion of the rear frame.
